(19) United States
(12) Patent Application Publication
(10) Pub. No.: US 2026/0149899 A1
(43) Pub. Date: May 28, 2026

(54) ANALOG TO DIGITAL CONVERTER AND IMAGE SENSOR DEVICE INCLUDING THEREOF

(71) Applicant: Samsung Electronics Co., Ltd., Suwon-si (KR)

(72) Inventors: Yunhong Kim, Suwon-si (KR); Sangwoo Kim, Suwon-si (KR)

(21) Appl. No.: 19/255,725

(22) Filed: Jun. 30, 2025

(30) Foreign Application Priority Data
Nov. 27, 2024 (KR) 10-2024-0172828
Dec. 31, 2024 (KR) 10-2024-0202589

(51) Int. Cl. H04N 25/78; H04N 25/60; H04N 25/77

(52) U.S. Cl. CPC H04N 25/78; H04N 25/60; H04N 25/77

(57) ABSTRACT

An image sensor device may include an image pixel configured to generate a pixel signal based on a light, a ramp generator including a ramp source circuit configured to generate a raw ramp signal, a driving source circuit configured to generate a driving source signal, and a bandwidth control circuit configured to generate a driving signal by adjusting a bandwidth of the driving source signal, and a ramp buffering circuit configured to generate a ramp signal corresponding to the raw ramp signal based on the driving signal, a comparative amplifier configured to generate a comparison output signal based on the pixel signal and the ramp signal, and an analog-to-digital conversion circuit generating a digital signal corresponding to the light based on the comparison output signal.

### CROSS-REFERENCE TO RELATED APPLICATIONS

This application claims priority to and the benefit of Korean Patent Application No. 10-2024-0172828 filed with the Korean Intellectual Property Office on Nov. 27, 2024, and Korean Patent Application No. 10-2024-0202589 filed with the Korean Intellectual Property Office on Dec. 31, 2024, the entire contents of each of which are incorporated herein by reference.

### BACKGROUND

An image sensor device may convert a light into a digital signal. For example, the image sensor device may include image pixels and an analog-to-digital converter.

The image pixel may convert the light into an analog voltage signal based on a power supply voltage. Accordingly, if the power supply voltage include noise, the analog voltage signal generated by the image pixel may also include noise.

### SUMMARY

An analog-to-digital converter connected to image pixels may include a ramp generator that generates a reference ramp signal. The analog-to-digital converter may generate a digital signal based on a result of comparing the analog voltage signal and the reference ramp signal. Therefore, if the noise included in the analog voltage signal is appropriately compensated based on the reference ramp signal, the noise included in the digital signal generated by the image sensor device may be minimized. However, if noise included in the analog voltage signal is not properly compensated based on the reference ramp signal, the digital signal generated by the image sensor device may include large noise components.

Some aspects of the present disclosure provide image sensor devices with improved compensation to remove noise from image sensor outputs.

According to some implementations of the present disclosure, an image sensor device may be provided. The image sensor device may include: an image pixel configured to generate a pixel signal based on a light; a ramp generator including: a ramp source circuit configured to generate a raw ramp signal; a driving source circuit configured to generate a driving source signal; and a bandwidth control circuit configured to generate a driving signal by adjusting a bandwidth of the driving source signal; and a ramp buffering circuit configured to generate a ramp signal corresponding to the raw ramp signal based on the driving signal; a comparative amplifier configured to generate a comparison output signal based on the pixel signal and the ramp signal; and an analog-to-digital conversion circuit generating a digital signal corresponding to the light based on the comparison output signal.

According to some implementations of the present disclosure, an image sensor device may be provided. The image sensor device may include: an image pixel array including a first image pixel, which is configured to operate based on a voltage level of a power supply line and configured to generate a first pixel signal corresponding to a voltage level of a first floating diffusion node; and a ramp generator configured to operate based on the voltage level of the power supply line and generate a first reference ramp signal corresponding to the first pixel signal, wherein the ramp generator includes: a driving source circuit configured to generate a driving source signal based on a capacitance replica circuit corresponding to a first power parasitic capacitance between the power supply line and the first floating diffusion node and a first floating diffusion capacitance of the first floating diffusion node; a first bandwidth control circuit configured to generate a first driving signal by adjusting a bandwidth of the driving source signal; and a first ramp buffering circuit configured to generate the first reference ramp signal based on the first driving signal.

According to some implementations of the present disclosure, an analog-to-digital converter may be provided. The analog-to-digital converter may include: a ramp generator configured to generate a ramp signal based on a power supply voltage provided from a power supply line; a comparative amplifier configured to generate a comparison output signal based on the ramp signal and a pixel signal provided from an image pixel operating based on the power supply voltage; and an analog-to-digital conversion circuit configured to generate a digital signal based on the comparison output signal, wherein the ramp generator includes a bandwidth control circuit configured to adjust, based on a first effective bandwidth of a first frequency response between the power supply voltage and the pixel signal, a second effective bandwidth of a second frequency response between the power supply voltage and the ramp signal.

### BRIEF DESCRIPTION OF THE DRAWINGS

FIG. 1 is a block diagram illustrating an example of an image sensor device.

FIG. 2 is a block diagram illustrating portions of the image sensor device of FIG. 1 in more detail.

FIG. 3 is a diagram illustrating portions of FIG. 2 in more detail.

FIG. 4 is a diagram illustrating an example of a ramp generator of FIG.

FIG. 5 is a diagram illustrating an example of a driving source circuit.

FIG. 6 is a diagram illustrating an example of a function of a bandwidth control circuit.

FIG. 7 is a diagram illustrating an example of a function of a bandwidth control circuit.

FIG. 8 is a graph illustrating an example of a voltage level of a comparison output signal.

FIG. 9 is a graph illustrating an example of a power supply rejection ratio PSRR of an image sensor device.

FIGS. 10 and 11 are a diagrams illustrating examples of bandwidth control circuits.

FIG. 12 is diagram illustrating an example of an analog-to-digital converter.

FIG. 13 is a diagram illustrating a portion of an example of an image sensor device.

FIG. 14 is a block diagram illustrating an example of an electronic device including a multi-camera module.

FIG. 15 is a block diagram illustrating an example of a camera module.

### DETAILED DESCRIPTION

It will be understood that various changes and modifications of the examples described herein may be made without departing from the scope and spirit of the present disclosure. Moreover, in the following description, some descriptions of well-known functions and structures are omitted for clarity and brevity.

Components that are described in the detailed description with reference to the terms “driver”, “block”, etc. will be implemented with software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, a microelectromechanical system (MEMS), a passive element, or a combination thereof.

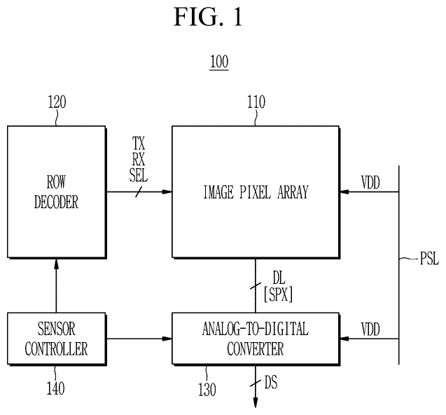

FIG. 1 is a block diagram illustrating an example of an image sensor device. Referring to FIG. 1, the image sensor device 100 may include an image pixel array 110, a row decoder 120, an analog-to-digital converter 130, and a sensor controller 140.

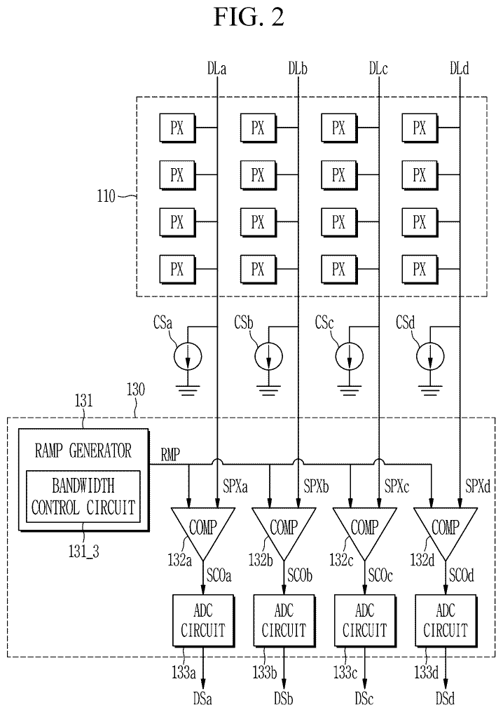

The image pixel array 110 may include a plurality of image pixels arranged in a row direction and a column direction, for example, as illustrated in FIG. 2. Each of the plurality of image pixels may generate a pixel signal SPX in response to control of the row decoder 120. For example, each of the plurality of image pixels may generate a reset pixel signal or a data pixel signal. Each of the plurality of image pixels may output the generated pixel signal SPX through the data lines DL. The pixel signal SPX may have a form of an analog voltage.

The row decoder 120 may be connected to the image pixel array 110 through a plurality of signal lines. The row decoder 120 may provide a reset signal RX, a transmission signal TX, and a select signal SEL to each of a plurality of image pixels through the plurality of signal lines.

The analog-to-digital converter 130 may be connected to the image pixel array 110 through the data lines DL. The analog-to-digital converter 130 may convert the pixel signals SPX into digital signals DS. For example, the analog-to-digital converter 130 may convert the voltage levels (e.g., analog voltage) of the data lines DL into the digital signals DS by sampling the voltage levels of the data lines DL. For example, the analog-to-digital converter 130 may generate a digital signal DS by performing a CDS (correlated double sampling) operation based on the reset pixel signal and the data pixel signal provided through the data line DL.

The image pixel array 110 and the analog-to-digital converter 130 may share a power supply line PSL. For example, both of the image pixel array 110 and the analog-to-digital converter 130 may receive a power supply voltage VDD through the one power supply line PSL. However, the power configuration is not limited thereto, and the image pixel array 110 and the analog-to-digital converter 130 may be configured to receive the power supply voltage VDD from one power supply circuit, or configured to receive the power supply voltage VDD from different power supply lines that are directly or indirectly connected to each other.

The power supply voltage VDD provided through the power supply line PSL may include noise. For example, the power supply voltage VDD may not be maintained with constant voltage level and but may rise and fall slightly. In this case, the pixel signal SPX output from the image pixel array 110 may also include noise. The analog-to-digital converter 130 may compensate for the noise included in the pixel signal SPX based on the power supply voltage VDD. In this case, a noise of an image corresponding to the digital signal DS may be minimized. A more detailed configuration and operation of the analog-to-digital converter 130 are described in more detail below.

The sensor controller 140 may control overall operations of the image sensor device 100. For example, the sensor controller 140 may control the operation timing of the row decoder 120 and the analog-to-digital converter 130.

FIG. 2 is a block diagram showing a part of the image sensor device of FIG. 1 in more detail. Although FIG. 2 illustrates that a plurality of image pixels PX are arranged along the first to fourth pixel rows and the first to fourth pixel columns of the image pixel array 110, the number of rows/columns is not limited thereto. For example, the image pixel array 110 may be expanded in the row direction and/or the column direction, and a plurality of image pixels may be further included in the image pixel array 110.

Referring to FIGS. 1 and 2, the image sensor device 100 may include the image pixel array 110 and the analog-to-digital converter 130. The image pixel array 110 may include a plurality of image pixels PX. Among the plurality of image pixels PX, image pixels located in a first pixel column may be connected to a first data line DLa, image pixels located in a second pixel column may be connected to a second data line DLb, image pixels located in a third pixel column may be connected to a third data line DLc, and image pixels located in a fourth pixel column may be connected to a fourth data line DLd.

In some implementations, image pixels included in the same pixel row within the image pixel array 110 may be connected to the row decoder 120 via the same signal lines. For example, image pixels included in the same pixel row may share signal lines. Accordingly, image pixels PX included in the same pixel row may receive the same signals from the row decoder 120. For example, image pixels PX included in the first pixel row may share a reset signal RX, a transmission signal TX, and a select signal SEL.

Each of the plurality of image pixels PX may generate the pixel signal SPX based on the reset signal RX and the transmission signal TX. Each of the plurality of image pixels PX may output the pixel signal SPX through a connected data line DL. For example, each of the plurality of image pixels PX may output the pixel signal SPX in response to the select signal SEL.

In some implementations, the pixel signal SPX output by each of the image pixels PX may be a reset pixel signal generated through a reset operation, or a data pixel signal generated through a transfer operation.

In some implementations, image pixels included in a single pixel row may share a reset signal RX, a transmission signal TX, and a select signal SEL. Therefore, the image pixels included in one pixel row may simultaneously generate pixel signals SPX and simultaneously output the pixel signals SPX to the data lines DL. In this case, pixel signals SPX generated by image pixels PX included in one pixel row may include noise with values corresponding to each other. Therefore, if the analog-to-digital converter 130 does not compensate for the noise component of the pixel signal SPX, horizontal noise may appear in the image represented by the plurality of digital signals DS. Some implementations of this disclosure include an analog-to-digital converter 130 that compensates for the noise component of the pixel signal SPX, as described in detail below.

First to fourth current sources CSa to CSd may be connected to the first to fourth data lines DLa to DLd, respectively. Each of the first to fourth current sources CSa to CSd may be a constant current source. However, the circuit configuration is not limited to this implementation method of the first to fourth current sources CSa to CSd.

The analog-to-digital converter 130 may include a ramp generator 131, first to fourth comparative amplifiers 132a to 132d, and first to fourth analog-to-digital conversion circuits 133a to 133d.

Each of the first to fourth comparative amplifiers 132a to 132d (or differential amplifiers) may correspond to a different pixel column. For example, the first to fourth comparative amplifiers 132a to 132d may be connected to the first to fourth data lines DLa to DLd, respectively.

The ramp generator 131 may generate a ramp signal RMP. The ramp generator 131 may provide the ramp signal RMP to each of the first to fourth comparative amplifiers 132a to 132d.

In some implementations, the ramp signal RMP may be a signal whose voltage level decreases linearly. However, the scope of the present disclosure is not limited to a specific waveform of the ramp signal RMP. For example, a ramp signal RMP may be implemented as a linearly increasing voltage.

In some implementations, the ramp generator 131 may also be referred to as a ramp generating circuit.

Each of the first to fourth comparative amplifiers 132a to 132d may receive a pixel signal SPX from a connected data line DL and a ramp signal RMP from a ramp generator 131. Each of the first to fourth comparative amplifiers 132a to 132d may generate a comparison output signal SCO by amplifying the difference between the received pixel signal SPX and the ramp signal RMP. That is, the ramp signal RMP may be utilized as a reference voltage signal for the voltage levels of the first to fourth data lines DLa to DLd. For example, the first comparative amplifier 132a may generate a first comparison output signal SCOa based on the ramp signal RMP and the first pixel signal SPXa. In this manner, the first to fourth comparative amplifiers 132a to 132d may generate first to fourth comparison output signals SCOa to SCOd based on the first to fourth pixel signals SPXa to SPXd, respectively.

In some implementations, the ramp signal RMP may also be referred to as a reference ramp signal.

The ramp generator 131 may include a bandwidth control circuit 131_3 (sometimes referred to as a frequency response control circuit or a spectral control circuit). The ramp generator 131 may adjust the bandwidth of the noise component of the power supply voltage VDD included in the ramp signal RMP based on the bandwidth control circuit 131_3. For example, the ramp generator 131 may adjust the bandwidth of the noise component included in the ramp signal RMP in accordance with the frequency band of the noise component included in the pixel signal SPX, based on the bandwidth control circuit 131_3. In this case, since the noise included in the ramp signal RMP may correspond to the noise included in each of the first to fourth pixel signals SPXa to SPXd, the noise component included in the first to fourth comparison output signals SCOa to SCOd may be reduced or minimized.

The first to fourth ADC circuits 133a to 133d may receive first to fourth comparison output signals SCOa to SCOd, respectively. The first to fourth ADC circuits 133a to 133d may generate first to fourth digital signals DSa to DSd based on the first to fourth comparison output signals SCOa to SCOd, respectively. For example, each of the first to fourth ADC circuits 133a to 133d may generate a digital signal DS based on a time length where the voltage level of the received comparison output signal SCO is above a specific voltage level. However, the scope of the present disclosure is not limited to this specific manner or method by which each of the first to fourth ADC circuits 133a to 133d generates a digital signal DS based on the voltage level of the comparison output signal SCO.

In some implementations, when the noise components included in the first to fourth comparison output signals SCOa to SCOd are reduced or minimized, the noise components included in the first to fourth digital signals DSa to DSd may be reduced or minimized. Therefore, according to some implementations of the present disclosure, noise (e.g., horizontal noise) included in an image generated based on the first to fourth digital signals DSa to DSd may be reduced or minimized.

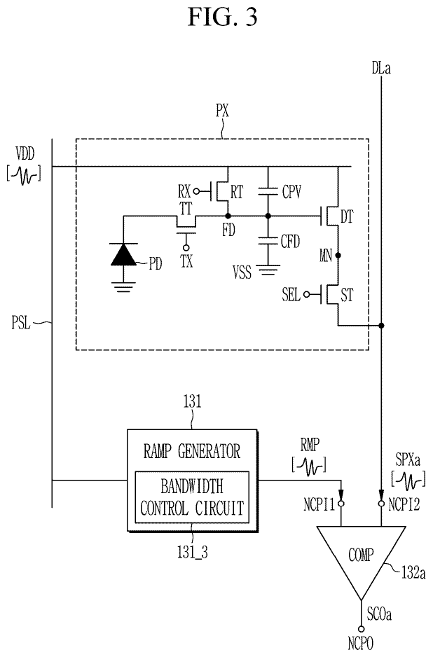

FIG. 3 is a diagram showing some of the configurations of FIG. 2 in more detail. With reference to FIG. 3, the operation of the image sensor device 100 corresponding to the first pixel column will be described in more detail.

Additionally, for convenience of explanation, it is assumed below that the image pixel PX has a 4TR-1PD (4-transistor, 1-photodiode) structure. However, the scope of the present disclosure is not limited thereto, and each of the image pixels PX included in the image pixel array 110 may be implemented in various forms, such as a 5TR-2PD (5-transistor, 2-photodiode) structure, a 6TR-3PD (6-transistor, 3-photodiode) structure, etc.

The image pixel PX may output a first pixel signal SPXa through a first data line DLa in response to a reset signal RX, a transmission signal TX, and a select signal SEL received from the row decoder 120. The image pixel PX may receive a power supply voltage VDD from the power supply line PSL.

The image pixel PX may include a photodiode PD, a transfer transistor TT, a reset transistor RT, a drive transistor DT, and a select transistor ST. The photodiode PD may generate charge in response to a light received from an external source (i.e., may convert photons into electrons).

The transfer transistor TT may be connected between the photodiode PD and a floating diffusion node FD. The transfer transistor TT may operate in response to a transmission signal TX from the row decoder 120. For example, the transmit transistor TT may be turned on in response to the transmission signal TX. In this case, charge may move from the photodiode PD to the floating diffusion node FD, the voltage level of the floating diffusion node FD may be decreased.

A floating diffusion capacitance CFD may form between the floating diffusion node FD and the ground voltage VSS. For example, a floating diffusion capacitor may be connected between the floating diffusion node FD and the ground voltage VSS in hardware form, or a parasitic capacitance may be formed between the floating diffusion node FD and the ground voltage VSS. In this case, the voltage level of the floating diffusion node FD may be maintained based on the voltage level stored in the floating diffusion capacitance CFD. However, the scope of the present disclosure is not limited to this specific manner by which the floating diffusion capacitance CFD is formed.

The reset transistor RT may be connected between the power supply voltage VDD and the floating diffusion node FD. The reset transistor RT may operate in response to the reset signal RX from the row decoder 120. For example, the reset transistor RT may be turned on in response to the reset signal RX. In this case, the voltage level of the floating diffusion node FD may be increased based on the power supply voltage VDD.

The drive transistor DT may be connected between the power supply voltage VDD and the middle node MN. The drive transistor DT may operate in response to the voltage of the floating diffusion node FD. For example, the gate terminal of the drive transistor DT may be connected to a floating diffusion node FD. The drive transistor DT may generate a first pixel signal SPXa based on the voltage of the floating diffusion node FD. For example, the drive transistor DT may operate as a source follower whose input terminal is connected to the floating diffusion node FD. The drive transistor DT may provide the first pixel signal SPXa to the middle node MN.

The select transistor ST may be connected between the middle node MN and the first data line DLa. The select transistor ST may operate in response to a select signal SEL. For example, the select transistor ST may be turned on in response to a select signal SEL. In this case, the first pixel signal SPXa may be provided to the first data line DLa.

In some implementations, the operation of charging the floating diffusion node FD based on the power supply voltage VDD may be referred to as a reset operation.

In some implementations, the operation of decreasing the voltage of the floating diffusion node FD by transferring charges from the photodiode PD to the floating diffusion node FD may be referred to as a transfer operation.

In some implementations, a first pixel signal SPXa generated by a drive transistor DT based on the voltage of the floating diffusion node FD charged through a reset operation may be referred to as a reset pixel signal.

In some implementations, a first pixel signal SPXa generated by a drive transistor DT based on a voltage of a floating diffusion node FD reduced by the transmission operation may be referred to as a data pixel signal.

A power parasitic capacitance CPV may be formed between the floating diffusion node FD and the power supply voltage VDD. Accordingly, the voltage level of the floating diffusion node FD may fluctuate due to fluctuations in the voltage level of the power supply voltage VDD. In other words, if noise occurs in the power supply voltage VDD, the voltage level of the floating diffusion node FD may be unintentionally fluctuated. In this case, noise may also be included in the first pixel signal SPXa generated based on the voltage level of the floating diffusion node FD.

The ramp generator 131 may receive a power supply voltage VDD from the power supply line PSL. The ramp generator 131 may generate a ramp signal RMP including noise corresponding to noise included in the first pixel signal SPXa, based on the power supply voltage VDD. For example, the ramp generator 131 may control, based on the bandwidth control circuit 131_3, the bandwidth of a frequency response between the power supply voltage VDD and the ramp signal RMP, based on a frequency response between the power supply voltage VDD and the first pixel signal SPXa. For example, the ramp generator 131 may control, based on the bandwidth control circuit 131_3, an effective bandwidth of the frequency response between the power supply voltage VDD and the ramp signal RMP, in accordance with an effective bandwidth determined based on the frequency response between the power supply voltage VDD and the first pixel signal SPXa. The more detailed configuration and operation of the ramp generator 131 are described in more detail below.

A first input terminal of the first comparative amplifier 132a may be connected to a first comparison input node NCPI1, a second input terminal of the first comparative amplifier 132a may be connected to a second comparison input node NCPI2, and an output terminal of the first comparative amplifier 132a may be connected to a comparison output node NCPO. The first comparison input node NCPI1 may be connected to the ramp generator 131, and the second comparison input node NCPI2 may be connected to the first data line DLa. The comparison output node NCPO may be connected to the first ADC circuit 133a.

The first comparative amplifier 132a may receive the ramp signal RMP through the first comparison input node NCPI1, and may receive the first pixel signal SPXa through the second comparison input node NCPI2. The first comparative amplifier 132a may generate the first comparison output signal SCOa based on the difference between the ramp signal RMP and the first pixel signal SPXa. The first comparative amplifier 132a may output the first comparison output signal SCOa to the comparison output node NCPO.

In some implementations, when the noise components included in the ramp signal RMP and the first pixel signal SPXa correspond to each other, the noise component included in a difference between the ramp signal RMP and the first pixel signal SPXa may be minimized. For example, if the ramp signal RMP and the first pixel signal SPXa include the same noise components, the difference between the ramp signal RMP and the first pixel signal SPXa may not include the noise components. In this case, the first comparative amplifier 132a may generate the first pixel signal SCOa by canceling out the noise components included in the ramp signal RMP and the first pixel signal SPXa. Therefore, according to some implementations of the present disclosure, the influence of noise of the power supply voltage VDD may be reduced.

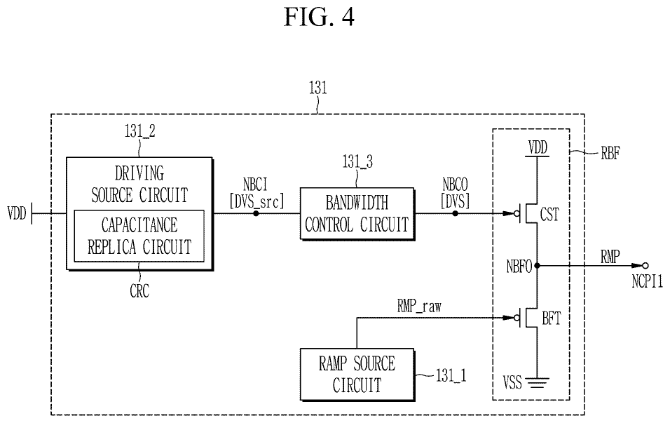

FIG. 4 is a drawing showing an example of a ramp generator, e.g., the ramp generator of FIG. 3. Referring to FIGS. 1 to 4, the ramp generator 131 may include a ramp source circuit 131_1, a driving source circuit 131_2, a bandwidth control circuit 131_3, and a ramp buffering circuit RBF.

The ramp source circuit 131_1 may generate a raw ramp signal RMP_raw. In some implementations, the raw ramp signal RMP_raw may be a signal whose voltage level decreases as time advances.

In some implementations, the ramp source circuit 131_1 may include a variable current source and a variable resistor connected between a power supply voltage VDD and a ground voltage VSS. In this case, the ramp source circuit 131_1 may generate the raw ramp signal RMP_raw based on the voltage level of the node between the variable current source and the variable resistor. However, the scope of the present disclosure is not limited to this specific manner for how the ramp source circuit 131_1 generates the raw ramp signal RMP_raw.

The ramp buffering circuit RBF may generate a ramp signal RMP based on the raw ramp signal RMP_raw. The ramp buffering circuit RBF may include a buffer transistor BFT and a current source transistor CST.

In some implementations, the buffer transistor BFT and the current source transistor CST may be implemented as a p-type channel metal-oxide semiconductor (PMOS) transistor. However, the type of transistor implementing the ramp buffering circuit RBF is not limited to the foregoing type.

The current source transistor CST may be connected between the buffer output node NBFO and the power supply voltage VDD. The gate terminal of the current source transistor CST may be connected to a bandwidth control output node NBCO. The current source transistor CST may receive a driving signal DVS through a bandwidth control output node NBCO. The current source transistor CST may operate as a current source based on the voltage level of the driving signal DVS. For example, the current source transistor CST may provide the current required for an operation of the buffer transistor BFT based on the driving signal DVS.

The buffer transistor BFT may be connected between the buffer output node NBFO and the ground voltage VSS. The buffer transistor BFT may operate based on the current provided from the current source transistor CST. For example, the buffer transistor BFT may operate as a source follower that generates the ramp signal RMP based on the current provided from the current source transistor CST and the raw ramp signal RMP_raw. In more detail, the gate terminal of the buffer transistor BFT may receive a raw ramp signal RMP_raw. In this case, the buffer transistor BFT may output the ramp signal RMP corresponding to the raw ramp signal RMP_raw to the first comparison input node NCPI1 through the buffer output node NBFO.

The ramp signal RMP (i.e., the voltage at the buffer output node NBFO) may vary depending on the magnitude of the current provided from the current source transistor CST. The amount of current provided by the current source transistor CST to the buffer transistor BFT may vary depending on the voltage level of the driving signal DVS. Therefore, if the driving signal DVS properly reflects the noise component of the power supply voltage VDD, the ramp signal RMP may include a noise component corresponding to the noise component in the pixel signal SPX.

The driving source circuit 131_2 may operate based on the power supply voltage VDD. The driving source circuit 131_2 may generate a driving source signal DVS_src in which noise components of the power supply voltage VDD are reflected or represented. For example, the driving source circuit 131_2 may include a capacitance replica circuit CRC. The capacitance replica circuit CRC may be implemented, based on the power supply voltage VDD, to reflect or represent a noise component which is generated in the floating diffusion node FD due to the power parasitic capacitance CPV of the image pixel PX, to the driving source signal DVS_src. The driving source circuit 131_2 may provide the driving source signal DVS_src to the bandwidth control input node NBCI.

The bandwidth control circuit 131_3 may control the bandwidth of the driving source signal DVS_src. For example, the bandwidth control circuit 131_3 may generate the driving signal DVS by reducing or expanding the bandwidth of the driving source signal DVS_src. The bandwidth control circuit 131_3 may adjust the bandwidth of the driving source signal DVS_src, so that the frequency response between the power supply voltage VDD and the ramp signal RMP corresponds to the frequency response between the power supply voltage VDD and the first pixel signal SPXa.

When the ramp generator 131 is implemented to directly provide the raw ramp signal RMP_raw to the first comparison input node NCPI1, the voltage level of the first comparison input node NCPI1 may change due to the coupling between the comparison output node NCPO and the first comparison input node NCPI1. In this case, since the noise component included in the first pixel signal SPXa may be reflected or represented in the first comparison output signal SCOa, horizontal noise may be included in the image generated by the image sensor device 100. In contrast, according to some implementations of the present disclosure, instead of the raw ramp signal RMP_raw being directly provided to the first comparison input node NCPI1, the ramp signal RMP may be provided to the first comparison input node NCPI1. In this case, the voltage level change of the first comparison input node NCPI1 due to the coupling between the comparison output node NCPO and the first comparison input node NCPI1 may be reduced. Accordingly, the first comparative amplifier 132a may compensate for (e.g., remove) a noise component included in the first pixel signal SPXa based on the ramp signal RMP, so that horizontal noise of an image generated by the image sensor device 100 may be reduced.

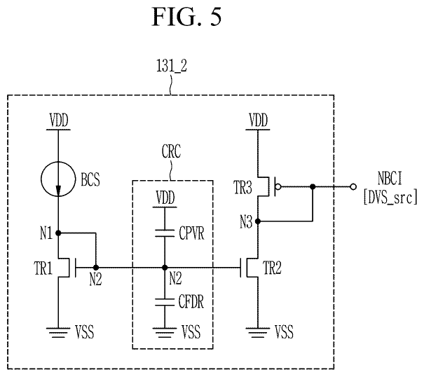

FIG. 5 is a diagram showing an example of a driving source circuit, e.g., the driving source circuit of FIG. 4. Referring to FIGS. 1 to 5, the driving source circuit 131_2 may include a bias current source BCS, a first transistor TR1, a capacitance replica circuit CRC, a second transistor TR2, and a third transistor TR3.

The bias current source BCS may be connected between the power supply voltage VDD and the first node N1. The bias current source BCS may provide bias current to the first node N1.

The first transistor TR1 may be connected between the first node N1 and the ground voltage VSS. The gate terminal of the first transistor TR1 may be connected to a second node N2. The second node N2 may be connected to the first node N1.

The capacitance replica circuit CRC may be connected to the second node N2. A capacitance replica circuit CRC may provide noise components of the power supply voltage VDD to the second node N2. For example, the capacitance replica circuit CRC may include a power parasitic capacitance replica capacitor CPVR and a floating diffusion capacitance replica capacitor CFDR. The power parasitic capacitance replica capacitor CPVR may be connected between the power supply voltage VDD and the second node N2. The floating diffusion capacitance replica capacitor CFDR may be connected between the second node N2 and the ground voltage VSS.

The capacitance ratio of the power parasitic capacitance replica capacitor CPVR and the floating diffusion capacitance replica capacitor CFDR may correspond to (e.g., substantially match) the capacitance ratio of the power parasitic capacitance CPV and the floating diffusion capacitance CFD within an image pixel PX. In this case, the noise component of the power supply voltage VDD may be provided to (e.g., affects) the second node N2 as much as the noise component of the power supply voltage VDD is provided to (e.g., affects) the floating diffusion node FD.

In some implementations, the capacitance ratio of the power parasitic capacitance replica capacitor CPVR and the floating diffusion capacitance replica capacitor CFDR may be determined based on the capacitance ratio of the power parasitic capacitance CPV and the floating diffusion capacitance CFD of each of the plurality of image pixels PX included in the image pixel array 110. For example, the capacitance ratio of the power parasitic capacitance replica capacitor CPVR and the floating diffusion capacitance replica capacitor CFDR may be determined as an average of the capacitance ratios of the power parasitic capacitances CPV and the floating diffusion capacitances CFD of the plurality of image pixels PX. However, the scope of the present disclosure is not limited to this specific manner in which the capacitance ratio of the power parasitic capacitance replica capacitor CPVR and the floating diffusion capacitance replica capacitor CFDR is determined. For example, the capacitance ratio of the power parasitic capacitance replica capacitor CPVR and the floating diffusion capacitance replica capacitor CFDR may be determined based on the capacitance ratio of the power parasitic capacitance CPV and the floating diffusion capacitance CFD for one representative image pixel PX; or may be determined based on an average of the capacitance ratios of the power parasitic capacitances CPV and the floating diffusion capacitances CFD for image pixels PX included in each pixel row.

In some implementations, each of the power parasitic capacitance replica capacitor CPVR and the floating diffusion capacitance replica capacitor CFDR may be implemented as a variable capacitor. In this case, the capacitance of each of the power parasitic capacitance replica capacitor CPVR and the floating diffusion capacitance replica capacitor CFDR may be determined based on the simulation results for the power parasitic capacitance CPV and the floating diffusion capacitance CFD for the image pixel PX performed in a production stage of the image sensor device 100. However, the scope of the present disclosure is not limited thereto.

A second transistor TR2 may be connected between a third node N3 and the ground voltage VSS. The gate terminal of the second transistor TR2 may be connected to the second node N2. As such, the first transistor TR1 and the second transistor TR2 may implement a current mirror. For example, a size of a current flowing from the third node N3 to the ground voltage VSS through the second transistor TR2 may be determined based on a size of a current of the bias current source BCS and a size of the noise component of the power supply voltage VDD.

The third transistor TR3 may be connected between the power supply voltage VDD and the third node N3. The gate terminal of the third transistor TR3 may be connected to the bandwidth control input node NBCI. A third node N3 may be connected to the bandwidth control input node NBCI. In this case, the voltage level of the bandwidth control input node NBCI may be determined based on the size of the current flowing from the third node N3 to the ground voltage VSS through the second transistor TR2. Accordingly, the voltage level of the bandwidth control input node NBCI (i.e., the driving source signal DVS_src) may include a noise component of the power supply voltage VDD.

When the driving source signal DVS_src is directly provided to the gate terminal of the current source transistor CST, a noise component of a specific frequency band of the power supply voltage VDD may be unequally included in the ramp signal RMP and the first pixel signal SPXa. For example, the difference between the frequency response from the power supply voltage VDD to the ramp signal RMP and the frequency response from the power supply voltage VDD to the first pixel signal SPXa may be very large in a specific frequency band. In this case, since the noise component of the specific frequency band may be included in the first comparison output signal SCOa (e.g., because the noise component is not canceled out between the ramp signal RMP and the first pixel signal SPXa), noise may be included in the image generated by the image sensor device 100.

On the other hand, according to some implementations of the present disclosure, the bandwidth control circuit 131_3 may provide, to the gate terminal of the current source transistor CST, the driving signal DVS generated by adjusting the bandwidth of the driving source signal DVS_src. In this case, noise components of all frequency bands of the power supply voltage VDD may be substantially equally included in the ramp signal RMP and the first pixel signal SPXa. For example, a magnitude of the frequency response from the power supply voltage VDD to the ramp signal RMP and a magnitude of the frequency response from the power supply voltage VDD to the first pixel signal SPXa may have similar values, or substantially match, in all frequency bands (e.g., all frequency bands of interest for noise removal). In this case, since the first comparative amplifier 132a may appropriately compensate (e.g., remove) noise components of all frequency bands of the power supply voltage VDD, noise in the image generated by the image sensor device 100 may be significantly reduced.

In some implementations, the power supply voltage VDD connected to each of the bias current source BCS, the power parasitic capacitance replica capacitor CPVR, and the third transistor TR3 may all be provided from the power supply line PSL. However, the circuit configuration is not limited thereto, and, for example, only the power supply voltage VDD connected to the power parasitic capacitance replica capacitor CPVR may be provided from the power supply line PSL.

In some implementations, the third transistor TR3 and the current source transistor CST may form a current mirror. For example, a size of a current generated by the current source transistor CST may be determined based on a size of a current flowing from the power supply voltage VDD through the third transistor TR3 to the third node N3 and a size of the bandwidth controlled by the bandwidth control circuit 131_3. However, the scope of the present disclosure is not limited thereto.

In some implementations, the first and second transistors TR1, TR2 may be implemented as n-type channel metal-oxide semiconductors (NMOS) transistor. The third transistor TR3 may be implemented as a PMOS (p-type channel metal-oxide semiconductor) transistor. However, the type(s) of transistor implementing the driving source circuit 131_2 are not limited to the foregoing.

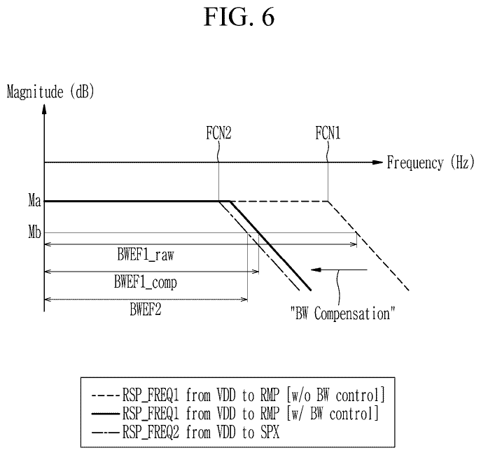

FIG. 6 is a diagram showing an example of a function of a bandwidth control circuit. The horizontal axis of FIG. 6 represents frequency expressed in a logarithmic scale, and the vertical axis represents the size of the frequency response in decibel units. For example, FIG. 6 may correspond to a bode magnitude plot, which approximately represents the magnitude of the frequency response.

Referring to FIGS. 1 to 6, the frequency response in a case where the power supply voltage VDD is an input signal and the ramp signal RMP is an output signal is referred to as a first frequency response REF_FREQ1. The frequency response in case where the power supply voltage VDD is an input signal and the pixel signal SPX (e.g., the first pixel signal SPXa) is an output signal is referred to as the second frequency response REF_FREQ2. The first frequency response REF_FREQ1 represents a frequency response between the power supply voltage VDD and the ramp signal RMP; and the second frequency response REF_FREQ2 represents a frequency response between the power supply voltage VDD and the pixel signal SPX. In other words, the first frequency response REF_FREQ1 indicates the degree to which a noise component included in the power supply voltage VDD affects the ramp signal RMP; and the second frequency response REF_FREQ2 indicates the degree to which a noise component included in the power supply voltage VDD affects the pixel signal SPX.

The bandwidth control circuit 131_3 may adjust the bandwidth of the driving source signal DVS_src with a bandwidth reduction scheme (e.g., low pass filtering, band pass filtering, etc.). For example, the bandwidth control circuit 131_3 may adjust the first effective bandwidth BWEF1 for the first frequency response REF_FREQ1, in accordance with the second effective bandwidth BWEF2 for the second frequency response REF_FREQ2, by reducing the bandwidth of the driving source signal DVS_src. Below, an example of a method by which the bandwidth control circuit 131_3 adjusts the first effective bandwidth BWEF1 is described in more detail.

The first frequency response REF_FREQ1 in the case where the bandwidth control circuit 131_3 does not control the bandwidth BW is illustrated as a dotted line. For example, the first frequency response REF_FREQ1 in a case where the driving source signal DVS_src is directly provided to the gate terminal of the current source transistor CST, or the bandwidth control input node NBCI and the bandwidth control output node NBCO is shorted, is illustrated by the dotted line.

Referring to the graph shown in the dotted line, in a frequency band below a first corner frequency FCN1 for the first frequency response REF_FREQ1, the magnitude of the first frequency response REF_FREQ1 is substantially a first magnitude Ma (more precisely, a value close to the first magnitude Ma). In a frequency band above the first corner frequency FCN1, the magnitude of the first frequency response REF_FREQ1 decreases as the frequency increases.

The second frequency response REF_FREQ2 is illustrated as a one-dot-one-dash line. Referring to the graph illustrated by the one-dot-one-dash line, in a frequency band below a second corner frequency FCN2 for the second frequency response REF_FREQ2, the magnitude of the second frequency response REF_FREQ2 is substantially the first magnitude Ma (more precisely, a value close to the first magnitude Ma). In a frequency band above the second corner frequency FCN2, the magnitude of the second frequency response REF_FREQ2 decreases as the frequency increases.

The first effective bandwidth BWEF1 may be defined as a bandwidth where the first frequency response REF_FREQ1 has an effective or significant size (e.g., significantly large size). For example, the first effective bandwidth BWEF1 may be the width of a frequency band in which the size of the first frequency response REF_FREQ1 is greater than or equal to a second size Mb. For a more detailed example, the first raw effective bandwidth BWEF1_raw may represent the effective bandwidth for a graph depicted by a dotted line.

The second effective bandwidth BWEF2 may be defined as a bandwidth where the second frequency response REF_FREQ2 has an effective or significant size. For example, the second effective bandwidth BWEF2 may be the width of a frequency band in which the size of the second frequency response REF_FREQ2 is greater than or equal to the second size Mb.

In some implementations, the second size Mb may be 3 dB smaller than the first size Ma. However, the scope of the present disclosure is not limited to this specific criteria for how effective bandwidth is determined. For example, the effective bandwidth may be determined as the width of the frequency band below the corner frequency FCN.

The first raw effective bandwidth BWEF1_raw may be different from the second raw effective bandwidth BWEF2. In this case, in a frequency band corresponding to the difference between the first raw effective bandwidth BWEF1_raw and the second effective bandwidth BWEF2, the magnitudes of the first frequency response REF_FREQ1 and the second frequency response REF_FREQ2 may be significantly different from each other. For example, the sizes of the first frequency response REF_FREQ1 and the second frequency response REF_FREQ2 may be slightly different from each other in a frequency band higher than the second corner frequency FCN2, but the sizes of the first frequency response REF_FREQ1 and the second frequency response REF_FREQ2 may be significantly different from each other in a frequency band corresponding to the difference between the first raw effective bandwidth BWEF1_raw and the second effective bandwidth BWEF2.

In other words, the frequency component of the noise of the power supply voltage VDD, where the frequency component is in the frequency band corresponding to the difference between the first raw effective bandwidth BWEF1_raw and the second effective bandwidth BWEF2, may be included in the pixel signal SPX and the ramp signal RMP with different sizes or magnitudes. In this case, the comparison output signal SCO may include noise components of the power supply voltage VDD.

A first frequency response REF_FREQ1 in the case where the bandwidth control circuit 131_3 controls or adjusts (e.g., compensates) the bandwidth BW is illustrated as a solid line. Referring to the graph shown in a solid line, as the bandwidth control circuit 131_3 reduces the bandwidth of the driving source signal DVS_src, the first raw effective bandwidth BWEF1_raw may be reduced in accordance with the second effective bandwidth BWEF2. For example, as the bandwidth control circuit 131_3 reduces the bandwidth of the driving source signal DVS_src, the first raw effective bandwidth BWEF1_raw may be reduced to the first compensated effective bandwidth BWEF1_comp.

The first compensated effective bandwidth BWEF1_comp may be similar to or substantially the same as the second effective bandwidth BWEF2, or otherwise more similar to the second effective bandwidth BWEF2 that is the first raw effective bandwidth BWEF1_raw. In this case, all or substantially all frequency components of the noise of the power supply voltage VDD may be included both in the pixel signal SPX and the ramp signal RMP in with same size. Therefore, according the noise component of the power supply voltage VDD included in the comparison output signal SCO may be significantly reduced.

In some implementations, as the bandwidth control circuit 131_3 compensates the bandwidth of the driving source signal DVS_src, the first compensated effective bandwidth BWEF1_comp may have a value substantially equal to the second effective bandwidth BWEF2. Furthermore, as the bandwidth control circuit 131_3 compensates the bandwidth of the driving source signal DVS_src, the second corner frequency FCN2 may have a value substantially the same as the first corner frequency FCN1. In this way, as the bandwidth control circuit 131_3 compensates the bandwidth of the driving source signal DVS_src, the first frequency response RSP_FREQ1 and the second frequency response RSP_FREQ2 may have substantially same magnitude in all frequency bands (and therefore, they may be illustrated with substantially same Bode plot).

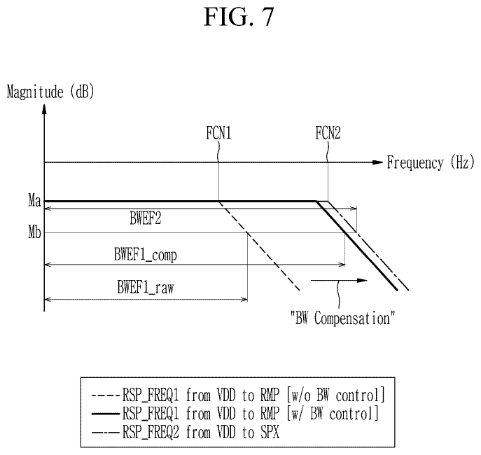

FIG. 7 is a diagram showing another example of function of the bandwidth control circuit. The horizontal axis of FIG. 7 represents frequency expressed in a logarithmic scale, and the vertical axis represents the size of the frequency response in decibel units. For example, FIG. 7 may correspond to a bode magnitude plot, which approximately represents the magnitude of the frequency response.

Referring to FIGS. 1 to 7, the bandwidth control circuit 131_3 may adjust the bandwidth of the driving source signal DVS_src using a bandwidth extension scheme. For example, the bandwidth control circuit 131_3 may expand the bandwidth of the driving source signal DVS_src to adjust the first effective bandwidth BWEF1 for the first frequency response REF_FREQ1 in accordance with the second effective bandwidth BWEF2 for the second frequency response REF_FREQ2.

The description of the first frequency response REF_FREQ1, the second frequency response REF_FREQ2, the first effective bandwidth BWEF1, and the second effective bandwidth BWEF2 is similar to that described above with reference to FIG. 6, so a detailed description is omitted.

That is, unlike what was described with reference to FIG. 6, the bandwidth control circuit 131_3 expands the bandwidth of the driving source signal DVS_src, such that, in comparison to the first raw effective bandwidth BWEF1_raw, the first compensated effective bandwidth BWEF1_comp is expanded in accordance with the second effective bandwidth BWEF2. For example, as the bandwidth control circuit 131_3 expands the bandwidth of the driving source signal DVS_src, the first raw effective bandwidth BWEF1_raw may be expanded as the first compensated effective bandwidth BWEF1_comp. In this case, since all frequency components of the noise of the power supply voltage VDD may be included in the pixel signal SPX and the ramp signal RMP with substantially same amount, the influence of the noise components of the power supply voltage VDD on the comparison output signal SCO may be significantly reduced.

For conciseness of explanation, an example will be described below in which the bandwidth control circuit 131_3 reduces the bandwidth of the driving source signal DVS_src to compensate the first frequency response REF_FREQ1 in accordance with the second frequency response REF_FREQ2. That is, hereinafter, similarly to what was explained with reference to FIG. 6 above, it is assumed that the first raw effective bandwidth BWEF1_raw is larger than the first compensated effective bandwidth BWEF1_comp. However, the scope of the present disclosure is not limited thereto, and the following description is equally applicable to configurations in which the bandwidth is expanded instead of reduced.

Additionally, the scope of the present disclosure is not limited to the form of the Bode plot described with reference to FIGS. 6 to 7. For example, in some implementations, the Bode plot for each frequency response may include two or more corner frequencies.

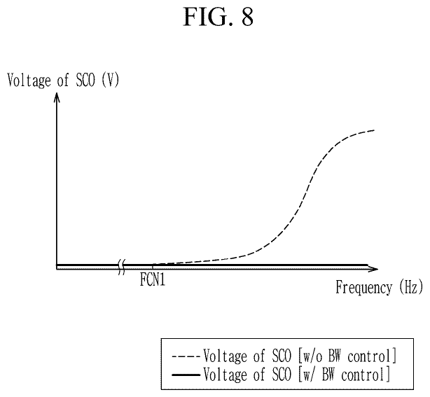

FIG. 8 is a graph showing an example of voltage level of a comparison output signal. The horizontal axis of FIG. 8 represents frequency, and the vertical axis represents the voltage of the comparison output signal SCO.

Hereinafter, with reference to FIGS. 1 to 8, it is assumed that the ramp generator 131 and the image pixel PX generate voltages of same size, and that the power supply voltage VDD includes noise components of same size (e.g., 1 V) in all frequency bands. Accordingly, the comparison output signal SCO in FIG. 8 is indicative of a noise component. In this case, if the image pixel PX and the ramp generator 131 operate ideally (for example, if there is no power parasitic capacitance CPV, etc.), since the ramp generator 131 and the image pixel PX generate voltages of same magnitude, the magnitude of the comparison output signal SCO may be ‘0 V’ in all frequency bands.

The size of the comparison output signal SCO when the bandwidth control circuit 131_3 does not control the bandwidth of the driving source signal DVS_src is illustrated by a dotted line. Referring to the graph shown in the dotted line, the size of the comparison output signal SCO may increase in a frequency band higher than the first corner frequency FCN1. In this case, unlike the case where the image pixel PX and the ramp generator 131 operate ideally, noise components in a frequency band higher than the first corner frequency FCN1 included in the power supply voltage VDD may be amplified through the comparative amplifier 132 and may be included in the comparison output signal SCO.

The size of the comparison output signal SCO when the bandwidth control circuit 131_3 controls the bandwidth of the driving source signal DVS_src is depicted by a solid line. Referring to the graph shown in the solid line, even in a frequency band higher than the first corner frequency FCN1, the comparison output signal SCO may be maintained at a size similar to ‘0 V’. In this case, similar to the case where the image pixel PX and the ramp generator 131 operate ideally, in all frequency bands, the noise component of the pixel signal SPX is canceled by the noise component of the ramp signal RMP, so that the noise component of the power supply voltage VDD may not be included (e.g., included very little) in the comparison output signal SCO.

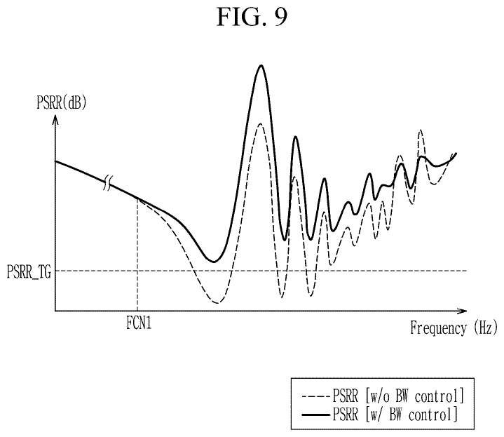

FIG. 9 is a graph showing an example of a power supply rejection ratio PSRR of an image sensor device. The horizontal axis of FIG. 9 represents frequency, and the vertical axis represents the size of PSRR.

Referring to FIGS. 1 to 9, PSRR indicates an endurance of the operation of the image sensor device 100 against the noise of the power supply voltage VDD. For example, PSRR may be defined based on the following Equation 1.

$$PSRR ( dB ) = \vert 20 \cdot log \frac{Δ V D D}{Δ C S O} \vert \qquad [ Equation 1 ]$$

Referring to the Equation 1, PSRR represents the size of PSRR, ΔVDD represents the noise of the power supply voltage VDD, and ΔCSO represents the noise of the comparison output signal SCO. Therefore, in an ideal scenario, the PSRR may have a very high value since ACSO may be close to ‘0’ regardless of the size of ΔVDD.

In some implementations, the larger PSRR may result in less noise included in the comparison output signal SCO. The smaller the PSRR, the greater the noise included in the comparison output signal SCO.

In some implementations, the target PSRR value PSRR_TG may be a criteria for determining whether noise included in the comparison output signal SCO is sufficiently small to be ignorable (e.g., such that the noise is not visible in an image generated by the image sensor device 100). For example, when the size of the PSRR is larger than a target PSRR value PSRR_TG, the noise included in the comparison output signal SCO may be small enough to be ignored. When the size of the PSRR is smaller than the target PSRR value PSRR_TG, the noise included in the comparison output signal SCO may be too large to be ignored.

The size of PSRR in the case where the bandwidth control circuit 131_3 does not control the bandwidth of the driving source signal DVS_src is illustrated by a dotted line. Referring to the graph shown in the dotted line, the magnitude of the PSRR in some frequency bands higher than the first corner frequency FCN1 may be lower than the target PSRR value PSRR_TG. That is, if the bandwidth control circuit 131_3 does not control the bandwidth of the driving source signal DVS_src, there may be a frequency band in which the size of the PSRR is lower than the target PSRR value PSRR_TG, and in such frequency band, the noise of the power supply voltage VDD may be significantly reflected in the comparison output signal SCO. In this case, error may occur in the digital signals DS due to noise in the comparison output signal SCO, and horizontal noise may occur in the image generated by the image sensor device 100.

The size of PSRR when the bandwidth control circuit 131_3 controls the bandwidth of the driving source signal DVS_src is illustrated as a solid line. Referring to the graph shown the solid line, the magnitude of PSRR in all frequency bands may be greater than the target PSRR value PSRR_TG. In this case, the noise of the comparison output signal SCO in all frequency bands may be small enough to be ignored, and the noise of the image generated by the image sensor device 100 may be significantly reduced.

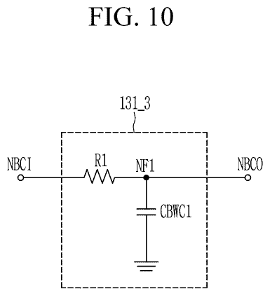

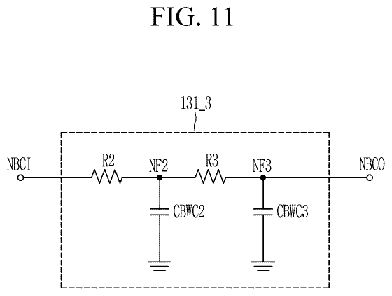

FIGS. 10 and 11 are diagrams showing examples of a bandwidth control circuit, e.g., the bandwidth control circuit of FIG. 4. Hereinafter, with reference to FIG. 10, an example in which the bandwidth control circuit 131_3 is implemented as a first-order low-pass filter is described, and with reference to FIG. 11, an example in which the bandwidth control circuit 131_3 is implemented as a second-order low-pass filter is described. However, the scope of the present disclosure is not limited to these circuit types for the bandwidth control circuit 131_3. For example, the bandwidth control circuit 131_3 may be implemented as a higher order low pass filter, a band pass filter, or a bandwidth expansion circuit.

First, referring to FIGS. 1 to 10, the bandwidth control circuit 131_3 may include a first resistor R1 and a first bandwidth control capacitor CBWC1.

The first bandwidth control capacitor CBWC1 may be connected between the first filtering node NF1 and the ground voltage VSS. The first resistor R1 may be connected between the bandwidth control input node NBCI and the first filtering node NF1. The first filtering node NF1 may be connected to the bandwidth control output node NBCO.

In some implementations, the first resistor R1 may be a parasitic resistor between the bandwidth control input node NBCI and the first filtering node NF1. However, the scope of the present disclosure is not limited thereto, and the first resistor R1 may be a resistor intentionally connected between the bandwidth control input node NBCI and the first filtering node NF1.

In some implementations, a resistor may also be connected between the first filtering node NF1 and the bandwidth control output node NBCO. However, the scope of the present disclosure is not limited thereto.

The bandwidth control circuit 131_3 may receive the driving source signal DVS_src through the bandwidth control input node NBCI and output the driving signal DVS through the bandwidth control output node NBCO. That is, the bandwidth control circuit 131_3 may generate the driving signal DVS by low-pass filtering the driving source signal DVS_src.

The degree to which the first frequency response RSP_FREQ1 being adjusted as the bandwidth control circuit 131_3 low-pass filters the driving source signal DVS_src may be determined based on the capacitance of the first bandwidth control capacitor CBWC1. For example, the difference between the first raw effective bandwidth BWEF1_raw and the first compensated effective bandwidth BWEF1_comp may be determined by the capacitance of the first bandwidth control capacitor CBWC1.

For example, the capacitance of the first bandwidth control capacitor CBWC1 may be determined so that the first compensated effective bandwidth BWEF1_comp becomes similar to the second effective bandwidth BWEF2. For example, the capacitance of the first bandwidth control capacitor CBWC1 may be determined based on the second effective bandwidth BWEF2 and the equivalent resistance between the power supply voltage VDD and the first comparison input node NCPI1.

In some implementations, the first bandwidth control capacitor CBWC1 may be implemented as a variable capacitor. In this case, the capacitance of the first bandwidth control capacitor CBWC1 may be determined based on simulation results for the second effective bandwidth BWEF2 performed in a production stage of the image sensor device 100. However, the scope of the present disclosure is not limited thereto.

Next, referring to FIGS. 1 to 9 and FIG. 11, the bandwidth control circuit 131_3 may include second and third resistors R2, R3, and second and third bandwidth control capacitors CBWC2, CBWC3.

The second bandwidth control capacitor CBWC2 may be connected between the second filtering node NF2 and the ground voltage VSS. The third bandwidth control capacitor CBWC3 may be connected between the third filtering node NF3 and the ground voltage VSS. The second resistor R2 may be connected between the bandwidth control input node NBCI and the second filtering node NF2. The second resistor R2 may be connected between the second filtering node NF2 and the third filtering node NF3. The third filtering node NF3 may be connected to a bandwidth control output node NBCO.

The capacitance of each of the second and third bandwidth control capacitors CBWC2, CBWC3 may be determined such that the first compensated effective bandwidth BWEF1_comp becomes similar to the second effective bandwidth BWEF2. The method by which the capacitance of each of the second and third bandwidth control capacitors CBWC2, CBWC3 is determined is similar to that described above with reference to FIG. 10, so a detailed description is omitted.

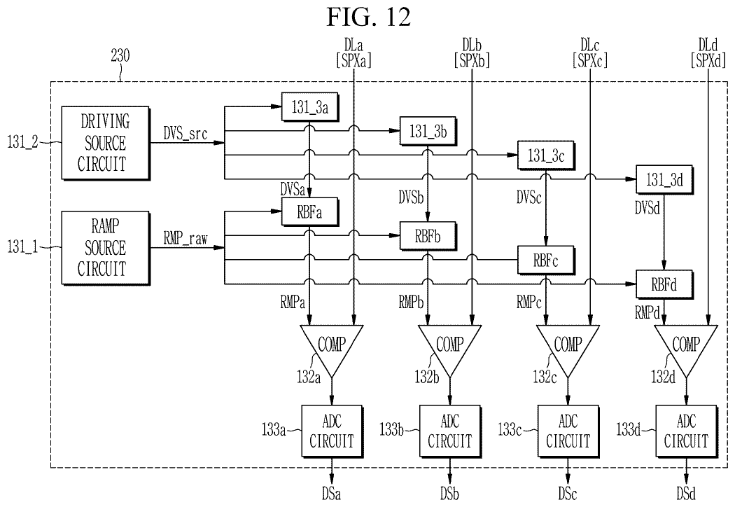

FIG. 12 is a drawing showing an example of a configuration of an analog-to-digital converter, e.g., the analog-to-digital converter of FIG. 1. Referring to FIGS. 1 to 12, the analog-to-digital converter 130 may be implemented as the analog-to-digital converter 230 shown in FIG. 12. Hereinafter, the differences between the analog-to-digital converter 130 and the analog-to-digital converter 230 will be mainly explained, and the analog-to-digital converter 230 may be substantially similar to the analog-to-digital converter 130 except for differences noted or suggested by context.

The analog-to-digital converter 230 may include a ramp source circuit 131_1, a driving source circuit 131_2, first to fourth comparative amplifiers 132a to 132d, and first to fourth ADC circuits 133a to 133d. The configuration and operation of each of the ramp source circuit 131_1, the driving source circuit 131_2, the first to fourth comparative amplifiers 132a to 132d, and the first to fourth ADC circuits 133a to 133d are similar to those described above with reference to FIGS. 1 to 11, and therefore, a detailed description is omitted.

The analog-to-digital converter 230 may include a bandwidth control circuit 131_3 and a ramp buffering circuit RBF provided for each pixel column. For example, the analog-to-digital converter 230 may include first to fourth bandwidth control circuits 131_3a to 131_3d and first to fourth ramp buffering circuits RBFa to RBFd. The first to fourth bandwidth control circuits 131_3a to 131_3d and the first to fourth ramp buffering circuits RBFa to RBFd may correspond to the first to fourth data lines DLa to DLd, respectively.

Each of the first to fourth bandwidth control circuits 131_3a to 131_3d may receive a driving source signal DVS_src from the driving source circuit 131_2. The first to fourth bandwidth control circuits 131_3a to 131_3d may respectively generate the first to fourth driving signals DVSa to DVSd by controlling the bandwidth of the driving source signal DVS_src.

Each of the first to fourth ramp buffering circuits RBFa to RBFd may receive a raw ramp signal RMP_raw from the ramp source circuit 131_1. The first to fourth ramp buffering circuits RBFa to RBFd may receive the first to fourth driving signals DVSa to DVSd, respectively. Each of the first to fourth ramp buffering circuits RBFa to RBFd may generate a ramp signal RMP based on the received raw ramp signal RMP_raw and the driving signal DVS. For example, the first to fourth ramp buffering circuits RBFa to RBFd may generate the first to fourth ramp signals RMPa to RMPd, respectively.

The first to fourth comparative amplifiers 132a to 132d may receive the first to fourth ramp signals RMPa to RMPd, respectively. In this case, the distance between a ramp buffering circuit RBF and a comparative amplifier 132 for each pixel column may be made uniform, and the distance between a bandwidth control circuit 131_3 and a ramp buffering circuit RBF for each pixel column may be made uniform. Therefore, based on configurations such as that shown in FIG. 12, the error between the comparison output signals SCO caused by the difference in the physical position of each pixel column may be reduced. However, the scope of the present disclosure is not limited thereto.

In some implementations, the analog-to-digital converter 230 may include one or more ramp source circuits 131_1 and/or one or more driving source circuits 131_2 for each pixel column. However, the scope of the present disclosure is not limited thereto.

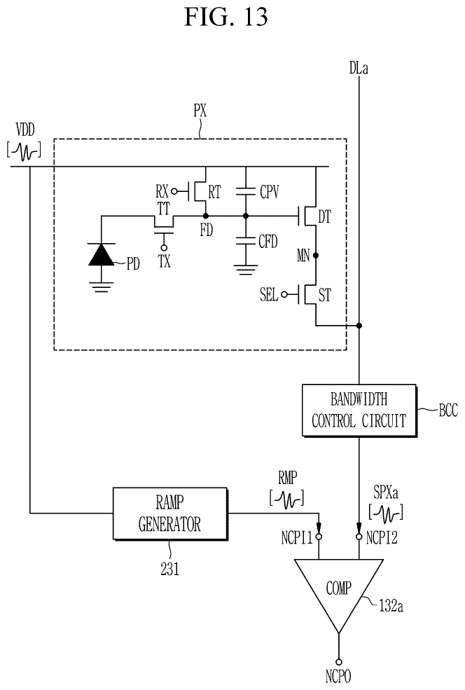

FIG. 13 is a drawing showing a portion of an example of an image sensor device. Hereinafter, a configuration corresponding to one pixel column will be described with reference to FIGS. 1 to 11 and FIG. 13.

The image sensor device 100 may include an image pixel PX, a ramp generator 231, a bandwidth control circuit BCC, and a comparative amplifier 132a.

The ramp generator 231 may be implemented similarly to the ramp generator 131 described above with reference to FIGS. 4 to 11. For example, the ramp generator 231 may generate a ramp signal RMP based on the power supply voltage VDD.

An image pixel PX may be connected to a first data line DLa. A bandwidth control circuit BCC may be connected between the first data line DLa and the comparative amplifier 132a. The bandwidth control circuit BCC may be implemented similarly to the bandwidth control circuit 131_3 described above with reference to FIGS. 4 to 11.

That is, a bandwidth control circuit BCC may be connected to the first data line DLa. In this case, the bandwidth control circuit BCC may control the bandwidth of the pixel signal SPX provided from the image pixel PX based on the effective bandwidth of the ramp signal RMP. For example, the bandwidth control circuit BCC may adjust the bandwidth of the pixel signal SPX to be more similar to the bandwidth of the ramp signal RMP. However, the scope of the present disclosure is not limited thereto.

In some implementations, the first data line DLa may further be connected to a first current source CSa as previously described with reference to FIG. 2. However, the scope of the present disclosure is not limited thereto.

For concise explanation, FIG. 13 is representatively illustrated as an example in which a bandwidth control circuit BCC is connected between the first data line DLa and the second comparison input node NCPI2, but the connection configuration of the bandwidth control circuit BCC is not limited thereto. For example, the bandwidth control circuit BCC may be connected between a drive transistor DT and a select transistor ST, or between a select transistor ST and a first data line DLa.

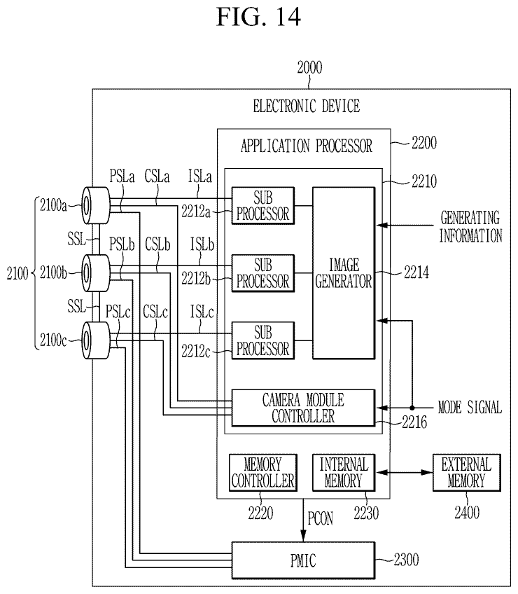

FIG. 14 is a block diagram of an example of an electronic device including a multi-camera module. Referring to FIG. 14, an electronic device 2000 may include a camera module group 2100, an application processor 2200, a PMIC 2300, and an external memory 2400.

The camera module group 2100 may include a plurality of camera modules 2100a, 2100b, and 2100c. An electronic device including three camera modules 2100a, 2100b, and 2100c is illustrated in FIG. 14, but the present disclosure is not limited thereto. In some implementations, the camera module group 2100 may include only two camera modules. Also, in some implementations, the camera module group 2100 may be modified to include “i” camera modules (i being a natural number of 4 or more).

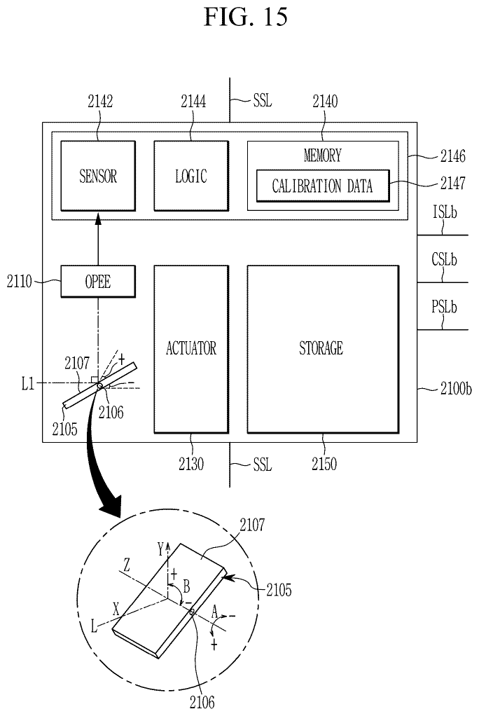

FIG. 15 is a block diagram illustrating the camera module of FIG. 14 in detail. Below, a detailed configuration of the camera module 2100b will be more fully described with reference to FIG. 15, but the following description may be equally applied to the remaining camera modules 2100a and 2100c.

Referring to FIG. 15, the camera module 2100b may include a prism 2105, an optical path folding element (OPFE) 2110, an actuator 2130, an image sensing device 2140, and storage 2150.

The prism 2105 may include a reflecting plane 2107 of a light reflecting material and may change a path of a light “L” incident from the outside.

In some implementations, the prism 2105 may change a path of the light “L” incident in a first direction (X) to a second direction (Y) perpendicular to the first direction (X), Also, the prism 2105 may change the path of the light “L” incident in the first direction (X) to the second direction (Y) perpendicular to the first (X-axis) direction by rotating the reflecting plane 2107 of the light reflecting material in direction “A” about a central axis 2106 or rotating the central axis 2106 in direction “B”. In this case, the OPFE 2110 may move in a third direction (Z) perpendicular to the first direction (X) and the second direction (Y).

In some implementations, as illustrated in FIG. 15, a maximum rotation angle of the prism 2105 in direction “A” may be equal to or smaller than 15 degrees in a positive A direction and may be greater than 15 degrees in a negative A direction, but the present disclosure is not limited thereto.

In some implementations, the prism 2105 may move within approximately 20 degrees in a positive or negative B direction, between 10 degrees and 20 degrees, or between 15 degrees and 20 degrees; here, the prism 2105 may move at the same angle in the positive or negative B direction or may move at a similar angle within approximately 1 degree.

In some implementations, the prism 2105 may move the reflecting plane 2107 of the light reflecting material in the third direction (e.g., Z direction) parallel to a direction in which the central axis 2106 extends.

The OPFE 2110 may include optical lenses composed of “m” groups (j being a natural number), for example. Here, “m” lens may move in the second direction (Y) to change an optical zoom ratio of the camera module 2100b. For example, when a default optical zoom ratio of the camera module 2100b is “Z”, the optical zoom ratio of the camera module 2100b may be changed to an optical zoom ratio of 3Z, 5Z or more by moving “m” optical lens included in the OPFE 2110.

The actuator 2130 may move the OPFE 2110 or an optical lens (hereinafter referred to as an “optical lens”) to a specific location. For example, the actuator 2130 may adjust a location of an optical lens such that an image sensor 2142 is placed at a focal length of the optical lens for accurate sensing.

The image sensing device 2140 may include the image sensor 2142, control logic 2144, and a memory 2146. The image sensor 2142 may sense an image of a sensing target by using the light “L” provided through an optical lens.

In some implementations, the image sensor 2142 may be implemented in a similar manner to the image sensor device 100 described above with reference to FIGS. 1 to 13, and may operate in a similar manner.

In some implementations, the image sensor 2142 may include an image pixel PX, a ramp generator 131, and a comparative amplifier 132. The image pixel PX and the ramp generator 131 may share the power supply voltage VDD. An image pixel PX may generate a pixel signal SPX and a ramp generator 131. A ramp generator 131 may control a frequency response between a power supply voltage VDD and a ramp signal RMP in accordance with a frequency response between a power supply voltage VDD and a pixel signal SPX. For example, the ramp generator 131 may include a bandwidth control circuit 131_3. The control logic 2144 may control overall operations of the camera module 2100b. For example, the control logic 2144 may control an operation of the camera module 2100b based on a control signal provided through a control signal line CSLb.

The memory 2146 may store information, which is necessary for an operation of the camera module 2100b, such as calibration data 2147. The calibration data 2147 may include information necessary for the camera module 2100b to generate image data by using the light “L” provided from the outside. The calibration data 2147 may include, for example, information about the degree of rotation described above, information about a focal length, information about an optical axis, etc. In the case where the camera module 2100b is implemented in the form of a multi-state camera in which a focal length varies depending on a location of an optical lens, the calibration data 2147 may include a focal length value for each location (or state) of the optical lens and information about auto focusing.

The storage 2150 may store image data sensed through the image sensor 2142. The storage 2150 may be disposed outside the image sensing device 2140 and may be implemented in a shape where the storage 2150 and a sensor chip constituting the image sensing device 2140 are stacked. In some implementations, the storage 2150 may be implemented with an electrically erasable programmable read only memory (EEPROM), but the present disclosure is not limited thereto.

Referring together to FIGS. 14 and 15, in some implementations, each of the plurality of camera modules 2100a, 2100b, and 2100c may include the actuator 2130. As such, the same calibration data 2147 or different calibration data 2147 may be included in the plurality of camera modules 2100a, 2100b, and 2100c depending on operations of the actuators 2130 therein.

In some implementations, one camera module (e.g., 2100b) among the plurality of camera modules 2100a, 2100b, and 2100c may be a folded lens shape of camera module in which the prism 2105 and the OPFE 2110 described above are included, and the remaining camera modules (e.g., 2100a and 2100c) may be a vertical shape of camera module in which the prism 2105 and the OPFE 2110 described above are not included; however, the present disclosure is not limited thereto.

In some implementations, one camera module (e.g., 2100c) among the plurality of camera modules 2100a, 2100b, and 2100c may be, for example, a vertical shape of depth camera extracting depth information by using an infrared ray (IR). In this case, the application processor 2200 may merge image data provided from the depth camera and image data provided from any other camera module (e.g., 2100a or 2100b) and may generate a three-dimensional (3D) depth image.

In some implementations, at least two camera modules (e.g., 2100a and 2100b) among the plurality of camera modules 2100a, 2100b, and 2100c may have different fields of view. In this case, the at least two camera modules (e.g., 2100a and 2100b) among the plurality of camera modules 2100a, 2100b, and 2100c may include different optical lens, but the present disclosure is not limited thereto.

Also, in some implementations, fields of view of the plurality of camera modules 2100a, 2100b, and 2100c may be different. In this case, the plurality of camera modules 2100a, 2100b, and 2100c may include different optical lens, not limited thereto.

In some implementations, the plurality of camera modules 2100a, 2100b, and 2100c may be disposed to be physically separated from each other. That is, the plurality of camera modules 2100a, 2100b, and 2100c may not use a sensing area of one image sensor 2142, but the plurality of camera modules 2100a, 2100b, and 2100c may include independent image sensors 2142 therein, respectively.

Returning to FIG. 14, the application processor 2200 may include an image processing device 2210, a memory controller 2220, and an internal memory 2230. The application processor 2200 may be implemented to be separated from the plurality of camera modules 2100a, 2100b, and 2100c. For example, the application processor 2200 and the plurality of camera modules 2100a, 2100b, and 2100c may be implemented with separate semiconductor chips.

The image processing device 2210 may include a plurality of sub image processors 2212a, 2212b, and 2212c, an image generator 2214, and a camera module controller 2216.

The image processing device 2210 may include the plurality of sub image processors 2212a, 2212b, and 2212c, the number of which corresponds to the number of the plurality of camera modules 2100a, 2100b, and 2100c.

Image data respectively generated from the camera modules 2100a, 2100b, and 2100c may be respectively provided to the corresponding sub image processors 2212a, 2212b, and 2212c through separated image signal lines ISLa, ISLb, and ISLc. For example, the image data generated from the camera module 2100a may be provided to the sub image processor 2212a through the image signal line ISLa, the image data generated from the camera module 2100b may be provided to the sub image processor 2212b through the image signal line ISLb, and the image data generated from the camera module 2100c may be provided to the sub image processor 2212c through the image signal line ISLc. This image data transmission may be performed, for example, by using a camera serial interface (CSI) based on the MIPI (Mobile Industry Processor Interface), but the present disclosure is not limited thereto.

Meanwhile, in some implementations, one sub image processor may be disposed to correspond to a plurality of camera modules. For example, the sub image processor 2212a and the sub image processor 2212c may be integrally implemented, not separated from each other as illustrated in FIG. 14; in this case, one of the pieces of image data respectively provided from the camera module 2100a and the camera module 2100c may be selected through a selection element (e.g., a multiplexer), and the selected image data may be provided to the integrated sub image processor.

The image data respectively provided to the sub image processors 2212a, 2212b, and 2212c may be provided to the image generator 2214. The image generator 2214 may generate an output image by using the image data respectively provided from the sub image processors 2212a, 2212b, and 2212c, depending on image generating information Generating Information or a mode signal.

For example, the image generator 2214 may generate the output image by merging at least a portion of the image data respectively generated from the camera modules 2100a, 2100b, and 2100c having different fields of view, depending on the image generating information Generation Information or the mode signal. Also, the image generator 2214 may generate the output image by selecting one of the image data respectively generated from the camera modules 2100a, 2100b, and 2100c having different fields of view, depending on the image generating information Generation Information or the mode signal.

In some implementations, the image generating information Generation Information may include a zoom signal or a zoom factor. Also, in some implementations, the mode signal may be, for example, a signal based on a mode selected from a user.

In some implementations, the image sensor 2142 of each of the camera modules 2100a, 2100b, 2100c may be implemented as an image sensor device 100 described above with reference to FIGS. 1 to 13. In this case, the influence of noise of the power supply voltage VDD on image data generated by each of the camera modules 2100a, 2100b, 2100c may be reduced. Therefore, the horizontal noise HN of an image generated by the image generator 2214 may be reduced.

In the case where the image generating information Generation Information is the zoom signal (or zoom factor) and the camera modules 2100a, 2100b, and 2100c have different visual fields of view, the image generator 2214 may perform different operations depending on a kind of the zoom signal. For example, in the case where the zoom signal is a first signal, the image generator 2214 may merge the image data output from the camera module 2100a and the image data output from the camera module 2100c and may generate the output image by using the merged image signal and the image data output from the camera module 2100b that is not used in the merging operation. In the case where the zoom signal is a second signal different from the first signal, without the image data merging operation, the image generator 2214 may select one of the image data respectively output from the camera modules 2100a, 2100b, and 2100c and may output the selected image data as the output image. However, the present disclosure is not limited thereto, and a way to process image data may be modified without limitation if necessary.

In some implementations, the image generator 2214 may generate merged image data having an increased dynamic range by receiving a plurality of image data of different exposure times from at least one of the plurality of sub image processors 2212a, 2212b, and 2212c and performing high dynamic range (HDR) processing on the plurality of image data.

The camera module controller 2216 may provide control signals to the camera modules 2100a, 2100b, and 2100c, respectively. The control signals generated from the camera module controller 2216 may be respectively provided to the corresponding camera modules 2100a, 2100b, and 2100c through control signal lines CSLa, CSLb, and CSLc separated from each other.

One of the plurality of camera modules 2100a, 2100b, and 2100c may be designated as a master camera (e.g., 2100b) depending on the image generating information including a zoom signal or the mode signal, and the remaining camera modules (e.g., 2100a and 2100c) may be designated as a slave camera. The above designation information may be included in the control signals, and the control signals including the designation information may be respectively provided to the corresponding camera modules 2100a, 2100b, and 2100c through the control signal lines CSLa, CSLb, and CSLc separated from each other.

Camera modules operating as a master and a slave may be changed depending on the zoom factor or an operating mode signal. For example, in the case where the field of view of the camera module 2100a is wider than the field of view of the camera module 2100b and the zoom factor indicates a low zoom ratio, the camera module 2100b may operate as a master, and the camera module 2100a may operate as a slave. In contrast, in the case where the zoom factor indicates a high zoom ratio, the camera module 2100a may operate as a master, and the camera module 2100b may operate as a slave.

In some implementations, the control signal provided from the camera module controller 2216 to each of the camera modules 2100a, 2100b, and 2100c may include a sync enable signal. For example, in the case where the camera module 2100b is used as a master camera and the camera modules 2100a and 2100c are used as a slave camera, the camera module controller 2216 may transmit the sync enable signal to the camera module 2100b. The camera module 2100b that is provided with sync enable signal may generate a sync signal based on the provided sync enable signal and may provide the generated sync signal to the camera modules 2100a and 2100c through a sync signal line SSL. The camera module 2100b and the camera modules 2100a and 2100c may be synchronized with the sync signal to transmit image data to the application processor 2200.

In some implementations, the control signal provided from the camera module controller 2216 to each of the camera modules 2100a, 2100b, and 2100c may include mode information according to the mode signal. Based on the mode information, the plurality of camera modules 2100a, 2100b, and 2100c may operate in a first operating mode and a second operating mode with regard to a sensing speed.

In the first operating mode, the plurality of camera modules 2100a, 2100b, and 2100c may generate image signals at a first speed (e.g., may generate image signals of a first frame rate), may encode the image signals at a second speed (e.g., may encode the image signal of a second frame rate higher than the first frame rate), and transmit the encoded image signals to the application processor 2200. In this case, the second speed may be 30 times or less the first speed.

The application processor 2200 may store the received image signals, that is, the encoded image signals in the memory 2230 provided therein or the external memory 2400 placed outside the application processor 2200. Afterwards, the application processor 2200 may read and decode the encoded image signals from the memory 2230 or the external memory 2400 and may display image data generated based on the decoded image signals. For example, the corresponding one among sub image processors 2212a, 2212b, and 2212c of the image processing device 2210 may perform decoding and may also perform image processing on the decoded image signal.

In the second operating mode, the plurality of camera modules 2100a, 2100b, and 2100c may generate image signals at a third speed (e.g., may generate image signals of a third frame rate lower than the first frame rate) and transmit the image signals to the application processor 2200. The image signals provided to the application processor 2200 may be signals that are not encoded. The application processor 2200 may perform image processing on the received image signals or may store the image signals in the memory 2230 or the external memory 2400.

The PMIC 2300 may supply powers, for example, power supply voltages to the plurality of camera modules 2100a, 2100b, and 2100c, respectively. For example, under control of the application processor 2200, the PMIC 2300 may supply a first power to the camera module 2100a through a power signal line PSLa, may supply a second power to the camera module 2100b through a power signal line PSLb, and may supply a third power to the camera module 2100c through a power signal line PSLc.

In response to a power control signal PCON from the application processor 2200, the PMIC 2300 may generate a power corresponding to each of the plurality of camera modules 2100a, 2100b, and 2100c and may adjust a level of the power. The power control signal PCON may include a power adjustment signal for each operating mode of the plurality of camera modules 2100a, 2100b, and 2100c. For example, the operating mode may include a low-power mode. In this case, the power control signal PCON may include information about a camera module operating in the low-power mode and a set power level. Levels of the powers respectively provided to the plurality of camera modules 2100a, 2100b, and 2100c may be identical to each other or may be different from each other. Also, a level of a power may be dynamically changed.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Although examples have been described in detail above, the scope of the present disclosure is not limited thereto, and various modifications and improvements made by those skilled in the art also fall within the scope of the present disclosure.

What is claimed is:

1. An image sensor device comprising:
an image pixel configured to generate a pixel signal based on a light;
a ramp generator including:
a ramp source circuit configured to generate a first ramp signal;
a driving source circuit configured to generate a driving source signal;
a bandwidth control circuit configured to generate a driving signal by adjusting a bandwidth of the driving source signal; and
a ramp buffering circuit configured to generate a second ramp signal corresponding to the first ramp signal based on the driving signal;
a differential amplifier configured to generate a comparison output signal based on the pixel signal and the second ramp signal; and
an analog-to-digital conversion circuit configured to generate, based on the comparison output signal, a digital signal corresponding to the light.

2. The image sensor device of claim 1, wherein the image pixel is configured to operate based on a power supply voltage provided through a power supply line, and wherein the ramp generator is configured to operate based on the power supply voltage provided through the power supply line.

3. The image sensor device of claim 2, wherein the image pixel comprises:
a photodiode configured to receive the light;
a transfer transistor connected between the photodiode and a floating diffusion node, wherein a gate of the transfer transistor is configured to receive a transmission signal;
a reset transistor connected between the power supply line and the floating diffusion node, wherein a gate of the reset transistor is configured to receive a reset signal;
a drive transistor connected between the power supply line and a middle node, wherein a gate of the drive transistor is configured to receive a voltage level of the floating diffusion node; and
a select transistor connected between the middle node and a data line, wherein the select transistor is configured to provide the pixel signal to the data line in response to a select signal.

4. The image sensor device of claim 3, wherein:
the driving source circuit comprises a capacitance replica circuit, and
the driving source circuit is configured to provide noise component of the power supply voltage into the driving source signal based on the capacitance replica circuit.

5. The image sensor device of claim 4, wherein:
the capacitance replica circuit comprises a first capacitor and a second capacitor connected in series between the power supply line and a ground voltage, and
a first capacitance ratio of (i) a capacitance of the first capacitor to (ii) a capacitance of the second capacitor substantially matches to a second capacitance ratio of (i) a capacitance between the power supply line and the floating diffusion node and (ii) a floating diffusion capacitance of the image pixel.

6. The image sensor device of claim 4, wherein the driving source circuit is configured to generate the driving source signal based on a bias current source and the capacitance replica circuit.

7. The image sensor device of claim 1, wherein the bandwidth control circuit is configured to generate the driving signal by low-pass filtering the driving source signal.

8. The image sensor device of claim 7, wherein the bandwidth control circuit comprises a low-pass filter configured to perform the low-pass filtering, wherein the low-pass filter comprises:
a bandwidth control input node configured to receive the driving source signal;
a bandwidth control output node configured to output the driving signal; and
a filtering node connected between the bandwidth control input node and the bandwidth control output node; and
a bandwidth control capacitor connected between the filtering node and a ground voltage.

9. The image sensor device of claim 8, wherein the capacitance of the bandwidth control capacitor is determined based on a frequency response between a power supply voltage and the pixel signal.

10. The image sensor device of claim 1, wherein the bandwidth control circuit is configured to generate the driving signal by expanding the bandwidth of the driving source signal.

11. The image sensor device of claim 1, wherein the ramp buffering circuit comprises:
a buffer output node configured to output the second ramp signal;
a buffer transistor connected between the buffer output node and a ground voltage, wherein a gate of the buffer transistor is configured to receive the first ramp signal; and
a current source transistor connected between a power supply voltage and the buffer output node, wherein a gate of the current source transistor is configured to receive the driving signal.

12. An image sensor device comprising:
an image pixel array comprising a first image pixel,
wherein the first image pixel is configured to operate based on a power supply voltage provided from a power supply line,
wherein the first image pixel is configured to generate a first pixel signal based on a voltage level of a first floating diffusion node, and
wherein noise component in the power supply voltage is provided to the first pixel signal based on a first power parasitic capacitance between the power supply line and the first floating diffusion node; and
a ramp generator,
wherein the ramp generator is configured to operate based on the power supply voltage provided from the power supply line, and
wherein the ramp generator is configured to generate a first reference ramp signal,
wherein the ramp generator comprises:
a driving source circuit configured to generate a driving source signal,
wherein the driving source circuit comprises a capacitance replica circuit,
wherein the driving source circuit is configured to provide the noise component into the driving source signal based on the capacitance replica circuit,
a first bandwidth control circuit configured to generate a first driving signal by adjusting a bandwidth of the driving source signal, and
a first ramp buffering circuit configured to generate the first reference ramp signal based on the first driving signal.

13. The image sensor device of claim 12, comprising:
a differential amplifier configured to generate a comparison output signal based on the first pixel signal and the first reference ramp signal; and
an analog-to-digital conversion circuit configured to generate a digital signal based on the comparison output signal.

14. The image sensor device of claim 12, wherein the first bandwidth control circuit is configured to generate the first driving signal by performing low-pass filtering or bandwidth expansion on the driving source signal.

15. The image sensor device of claim 12, wherein:
the ramp generator includes a ramp source circuit configured to generate a first ramp signal, and
the ramp buffering circuit comprises:
a buffer output node configured to output the first reference ramp signal;
a buffer transistor connected between the buffer output node and a ground voltage, wherein a gate of the buffer transistor is configured receive the first ramp signal; and
a current source transistor connected between the power supply line and the buffer output node, wherein a gate of the current source transistor is configured to receive the first driving signal.

16. The image sensor device of claim 12, wherein:
the image pixel array further comprises a second image pixel,
wherein the second image pixel is configured to operate based on the power supply voltage provided from the power supply line, and
wherein the second image pixel is configured to generate a second pixel signal based on a voltage level of a second floating diffusion node; and
the ramp generator further comprises:
a second bandwidth control circuit configured to generate a second driving signal by adjusting a bandwidth of the driving source signal;
a second ramp buffering circuit configured to generate a second reference ramp signal based on the second driving signal; and
a second differential amplifier configured to generate a second comparison output signal based on the second pixel signal and the second reference ramp signal.

17. An analog-to-digital converter comprising:
a ramp generator configured to generate a ramp signal based on a power supply voltage;
a comparative amplifier configured to generate a comparison output signal based on (i) the ramp signal and (ii) a pixel signal provided from an image pixel, wherein the image pixel is configured to operate based on the power supply voltage; and
an analog-to-digital conversion circuit configured to generate a digital signal based on the comparison output signal,
wherein the ramp generator includes a bandwidth control circuit configured to adjust, based on a first effective bandwidth of a first frequency response between the power supply voltage and the pixel signal, a second effective bandwidth of a second frequency response between the power supply voltage and the ramp signal.

18. The analog-to-digital converter of claim 17, wherein:
the ramp generator further includes a driving source circuit, a ramp source circuit, and a ramp buffering circuit,
the driving source circuit is configured to generate a driving source signal,
the ramp source circuit is configured to generate a raw ramp signal,
the bandwidth control circuit is configured to generate a driving signal by adjusting a bandwidth of the driving source signal, and
the ramp buffering circuit is configured to generate the ramp signal based on the raw ramp signal and the driving signal.

19. The analog-to-digital converter of claim 18, wherein the ramp buffering circuit comprises:
a buffer output node configured to output the ramp signal;
a buffer transistor connected between the buffer output node and a ground voltage, wherein a gate of the buffer transistor is configured to receive the raw ramp signal; and
a current source transistor connected between the power supply voltage and the buffer output node, wherein a gate of the current source transistor is configured to receive the driving signal.

20. The analog-to-digital converter of claim 19, wherein the driving source circuit comprises:
a bias current source connected between the power supply voltage and a first node;
a first transistor including a first gate terminal connected to a second node, wherein the first transistor is connected between the first node and a ground voltage;
a second transistor including a second gate terminal connected to the second node, wherein the second transistor is connected between a third node and the ground voltage;
a third transistor including a third gate terminal connected to a bandwidth control input node at which the driving source signal is output, wherein the third transistor is connected between the third node and the power supply voltage;
a first capacitor connected between the second node and the power supply voltage; and
a second capacitor connected between the second node and the ground voltage,
wherein the first node and the second node are connected to each other, the third node and the bandwidth control input node are connected to each other, and the bandwidth control circuit is connected between the bandwidth control input node and a bandwidth control output node at which the driving signal is output.
